(19) United States
(12) Patent Application Publication
(10) Pub. No.: US 2008/0056709 A1
(43) Pub. Date: Mar. 6, 2008

(54) Locating structure for eyeball-shaped camera

(75) Inventor: Wei-An Huang, Shulin City (TW)

Correspondence Address: BRUCE H. TROXELL, SUITE 1404, 5205 LEESBURG PIKE, FALLS CHURCH, VA, 22041, US

(73) Assignee: PROTECH OPTRONICS CO., LTD.

(21) Appl. No.: 11/514,331

(22) Filed: Sep. 1, 2006

(51) Int. Cl. G03B 17/00

(52) U.S. Cl. 396/427

(57) ABSTRACT

A locating structure is provided to firmly hold an eyeball-shaped camera to a desired surveillance angle without the risk of rotating automatically. The eyeball-shaped camera is confined within a space defined between a fixing housing and a mounting board. The fixing housing is provided with an opening, which has an inner diameter smaller than an outer diameter of the camera but larger than a camera lens glass of the camera, such that the camera lens glass is projected from the fixing housing to capture images of surroundings for surveillance purpose. A threaded pin is screwed into the fixing housing to support and push against a rear end of the eyeball-shaped camera, so that the camera is firmly held to the fixing housing between the opening and the threaded pin.

### FIELD OF THE INVENTION

The present invention relates to a locating structure for firmly holding an eyeball-shaped camera to an adjusted camera angle for capturing images of a place being surveilled.

### BACKGROUND OF THE INVENTION

A surveillance system has been widely used as a security means to surveil all entrances and exits as well as people and goods passing therethrough, so as to protect the safety of people and goods. The surveillance system is basically equipped with a surveillant camera, a host, and a monitor. The camera captures images and transmits the captured images to the host, so that the images are shown on the monitor for viewing by a security guard.

There are many different types of surveillant cameras available for the surveillance system. A user may select the surveillant camera according to actual conditions of the space and place to be surveilled.

An eyeball-shaped camera is one of the surveillant cameras, and has been used for many years due to its simple housing structure that allows easy and quick mounting of the camera. FIG. 1 shows a conventional structure for fixing an eyeball-shaped camera 10. As shown, the camera 10 is fixedly screwed to and between two brackets 12 using two screws 11. The two brackets 12 are fixedly connected to a top of a mounting board 13. A housing 14 is connected to the mounting board 13 to cover the two brackets 12 while a camera lens glass 15 of the eyeball-shaped camera 10 is exposed from the housing 14. The eyeball-shaped camera 10 may be pivotally turned about the two screws 11 and thereby adjusted to a desired surveillance direction for capturing images. However, as a matter of fact, the two screws 11 do not function to immovably hold the eyeball-shaped camera 10 to the adjusted position. The tightened screws 11 tend to become loosened after a short period of time to result in change of surveillance direction of the eyeball-shaped camera 10.

FIGS. 2 and 3 are assembled and exploded perspective views showing another conventional mounting structure for an eyeball-shaped camera 10. As shown, the camera 10 is directly locked to a housing 17 using to screws 16. Again, the two tightened screws 17 tend to become loosened after a short period of time to result in change of surveillance direction of the eyeball-shaped camera 10.

It is therefore tried by the inventor to develop a locating structure for eyeball-shaped camera, so that an eyeball-shaped camera could be exactly held to an adjusted camera angle to ensure and enhance the surveillance effect.

### SUMMARY OF THE INVENTION

A primary object of the present invention is to provide a locating structure for firmly holding an eyeball-shaped camera to adjusted angle and position for surveillance purpose, so that the eyeball-shaped camera is effective in a surveillance system.

To achieve the above and other objects, the locating structure for eyeball-shaped camera according to the present invention includes a mounting board, an eyeball-shaped camera, and a fixing housing. The fixing housing is connected at a first end to the mounting board, so that the eyeball-shaped camera is confined to a space defined between the fixing housing and the mounting board. The fixing housing is provided at a second end opposite to the first end with an opening, which has an inner diameter smaller than an outer diameter of the camera but larger than a camera lens glass of the camera, such that the camera lens glass is projected from the fixing housing to capture images of surroundings for surveillance purpose. A threaded pin is screwed through a wall of the fixing housing. By adjusting a length of the threaded pin extended into the fixing housing, the threaded pin is able to support and push against a rear end of the eyeball-shaped camera, so that the camera is firmly held to the fixing housing between the opening and the threaded pin.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein FIG. 1 is a perspective view showing a conventional locating structure for eyeball-shaped camera;

FIG. 2 is an assembled perspective view showing another conventional locating structure for eyeball-shaped camera;

FIG. 3 is an exploded view of FIG. 2;

FIG. 4 is an assembled perspective view showing a locating structure for eyeball-shaped camera according to a preferred embodiment of the present invention;

FIG. 5 is an exploded view of FIG. 4;

FIG. 6 is a sectioned side view of FIG. 4; and

FIG. 7 is a sectioned side view showing a locating structure for eyeball-shaped camera according to another embodiment of the present invention.

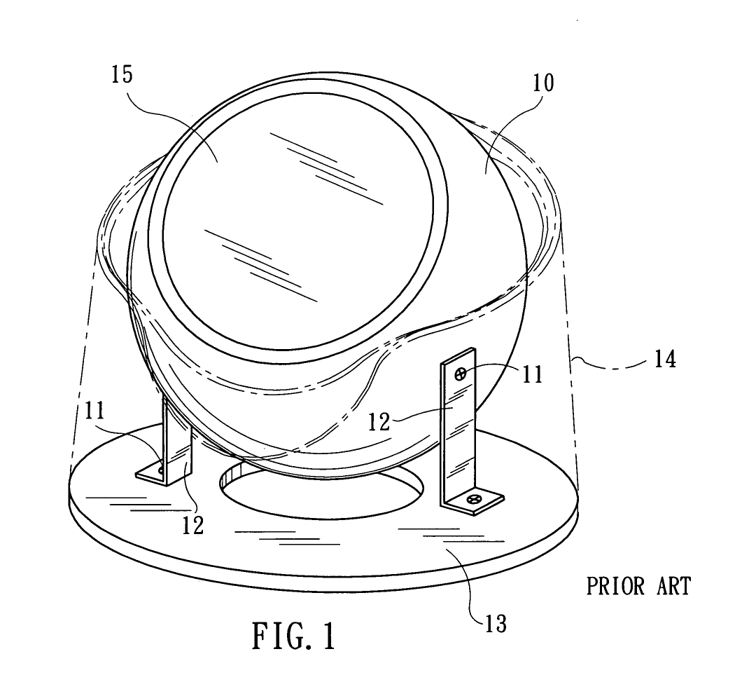

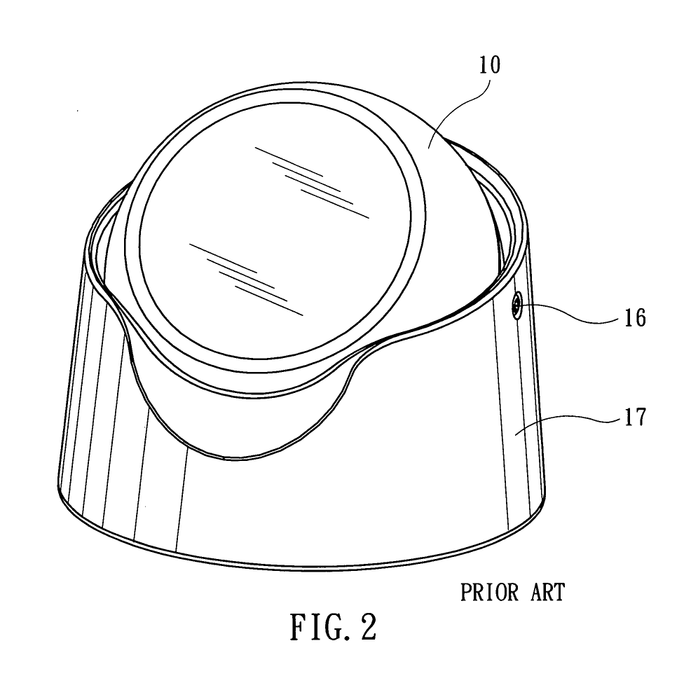

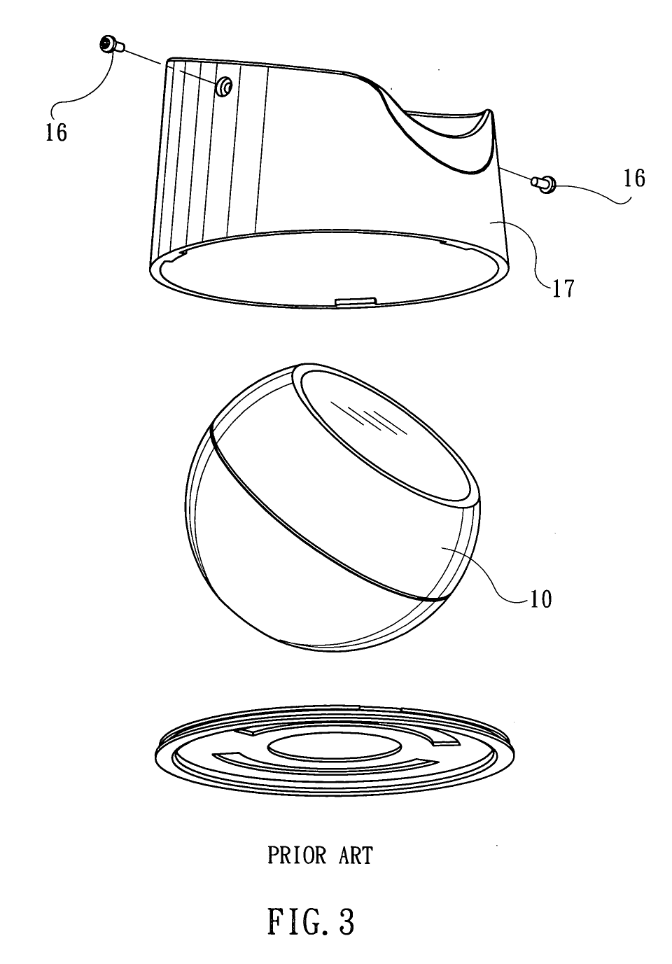

### DETAILED DESCRIPTION OF THE PREFERRED EMBODIMENTS

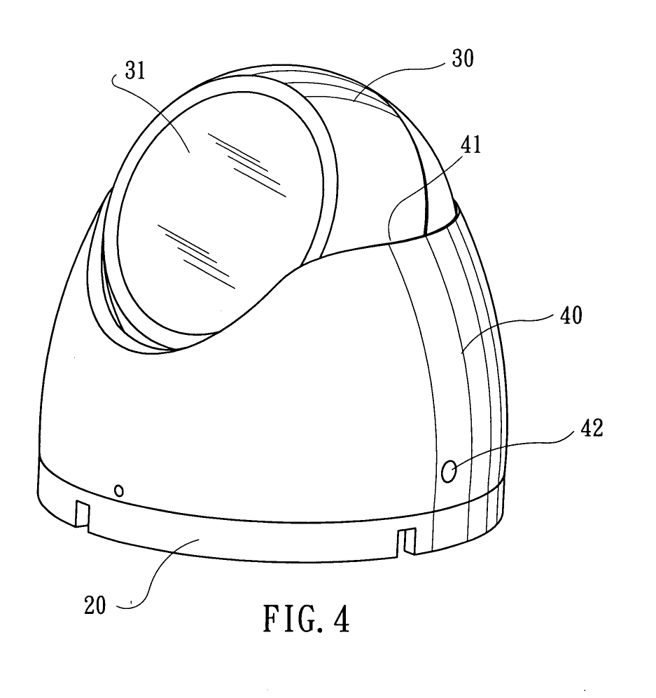

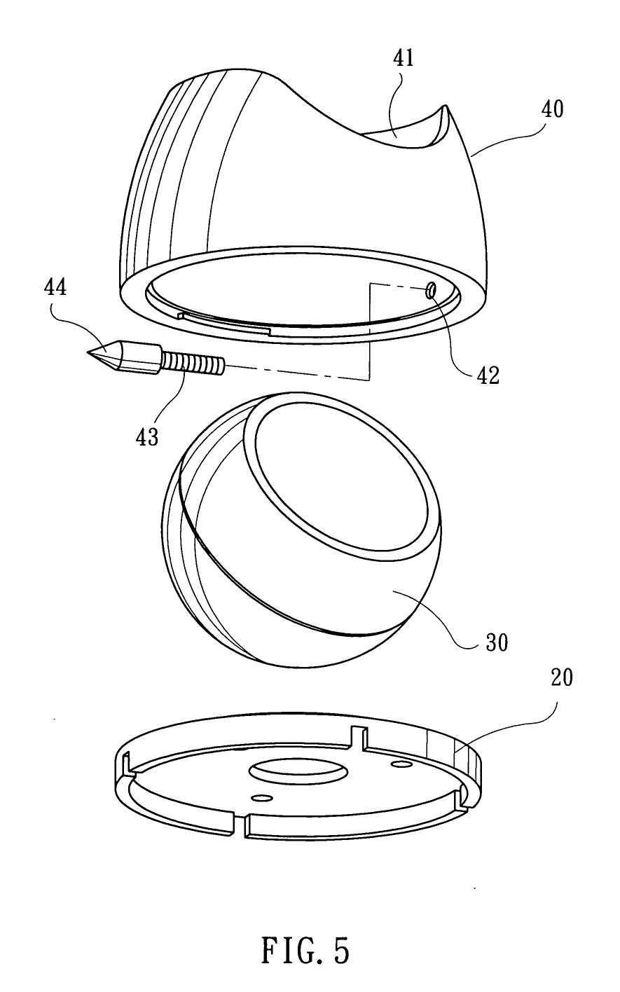

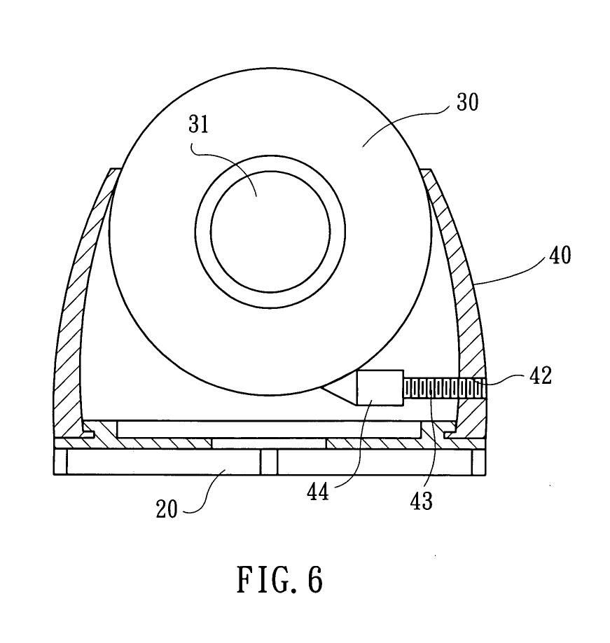

Please refer to FIGS. 4 and 5 that are assembled and exploded perspective views, respectively, showing a locating structure for eyeball-shaped camera according to a preferred embodiment of the present invention. As shown, the locating structure includes a mounting board 20, an eyeball-shaped camera 30, and a fixing housing 40. The eyeball-shaped camera 30 is normally used in a surveillance system for capturing images to achieve surveilling and controlling purpose. The mounting board 20 may be fixedly mounted to a ceiling or a wall to serve as a base board for installing a complete set of camera thereon. The eyeball-shaped camera 30 has a substantially spherical configuration with a flat camera lens glass 31 provided on a predetermined position thereof. A lens assembly (not shown) of the eyeball-shaped camera 30 is invisibly located behind the camera lens glass 31. The fixing housing 40 is connected at a first end to the mounting board 20 to confine the eyeball-shaped camera 30 within a space between the fixing housing 40 and the mounting board 20.

The fixing housing 40 is formed at a second end opposite to the first end with an opening 41, which has an inner diameter smaller than an outer diameter of the eyeball-shaped camera 30 but larger than an outer diameter of the camera lens glass 31, such that the camera lens glass 31 of the eyeball-shaped camera 30 may be projected from the fixing housing 40 to capture images of surroundings for the purpose of surveillance. The fixing housing 40 is provided at a predetermined position on a wall thereof with a threaded through hole 42, through which a threaded pin 43 may be screwed to extend into the fixing housing 40. By adjusting a length of the threaded pin 43 extended into the fixing housing 40, the threaded pin 43 may well support and push against a rear end of the eyeball-shaped camera 30 inside the fixing housing 40. With a front side being stopped by the opening 41 of the fixing housing 40 from moving outward, and a rear end being supported and pushed against by the threaded pin 43, the eyeball-shaped camera 30 is firmly held to the fixing housing 40 between the opening 41 and the threaded pin 43. When the eyeball-shaped camera 30 has been adjusted to a desired direction for surveillance, an operator may simply push the threaded pin 43 against the rear end of the camera 30 to firmly hold the camera 30 in place without the risk of moving or rotating.

One example of the threaded pin 43 may include a headless screw having a plastic-made tapered head 44 connected to a front end thereof. The tapered head 44 has a pointed front end to facilitate the approach of the threaded pin 43 to the rear end of the eyeball-shaped camera 30. When the length of the threaded pin 43 extended into the fixing housing 40 is gradually increased, the eyeball-shaped camera 30 is gradually pushed upward by the threaded pin 43 and finally firmly held in place between the opening 41 and the threaded pin 43.

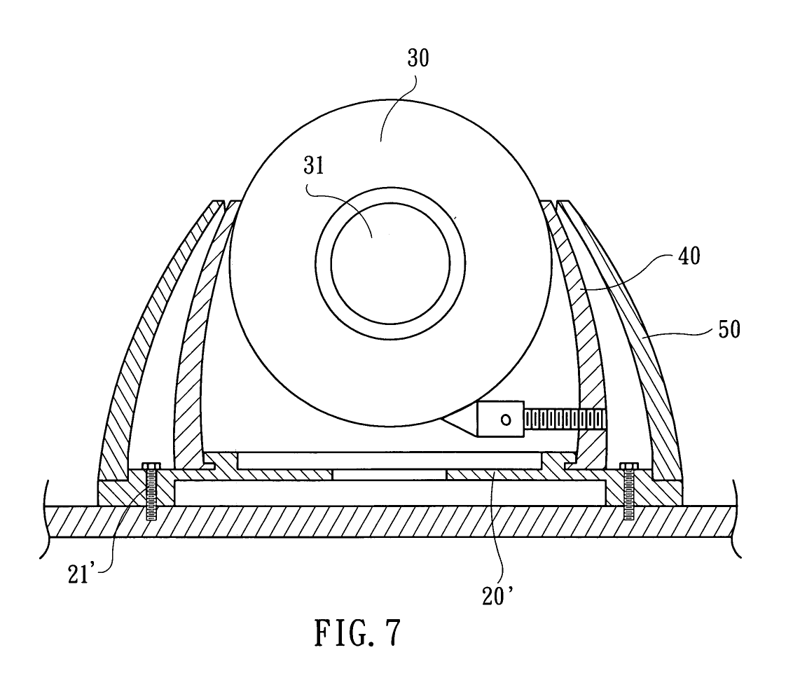

In another embodiment of the present invention as shown in FIG. 7, an ornamental shell 50 may be mounted to an outer side of the fixing housing 40 to shield the latter. The ornamental shell 50 is fixed to a mounting board 20′, which has mounting holes 21′ provided between the fixing housing 40 and the ornamental shell 50. The mounting board 20′ is first fixedly mounted to a ceiling or a wall surface, and an operator may then easily assemble the fixing housing 40 to the mounting board 20′ and then adjusts the eyeball-shaped camera 30 to a desired surveillance position.

The locating structure for eyeball-shaped camera according to the present invention is not only structurally simple and easy to handle, but also capable of firmly holding the eyeball-shaped camera to a desired surveillance angle and position to ensure and enhance the performance of a surveillance system. Moreover, the present invention may be manufactured at reduced cost to thereby increase the competitive edge of the eyeball-shaped camera and/or the whole surveillance system employing such eyeball-shaped camera and locating structure.

What is claimed is:

1. A locating structure for eyeball-shaped camera, comprising:
a mounting board for mounting to a ceiling and for other related components to install thereon;
an eyeball-shaped camera having a substantially spherical configuration, and being provided at a predetermined position with a flat camera lens glass, behind which a lens assembly inside said eyeball-shaped camera is invisibly located; and
a fixing housing being connected at a first end to said mounting board, so as to confine said eyeball-shaped camera within a space defined between said fixing housing and said mounting board; said fixing housing having an opening formed at a second end opposite to said first end, said opening having an inner diameter smaller than an outer diameter of said eyeball-shaped camera but larger than an outer diameter of said camera lens glass to thereby allow said camera lens glass of said eyeball-shaped camera to project from said fixing housing; and said fixing housing being provided at a predetermined position on a wall thereof with a threaded pin to support and push against a rear end of said eyeball-shaped camera, such that said eyeball-shaped camera is firmly held to said fixing housing between said opening and said threaded pin.

2. The locating structure for eyeball-shaped camera as claimed in claim 1, wherein said threaded pin includes a plastic-made tapered head connected to a front end of said threaded pin, such that said tapered head supports and pushes against the rear end of said eyeball-shaped camera.

3. The locating structure for eyeball-shaped camera as claimed in claim 1, wherein said fixing housing is provided on the wall thereof with a threaded through hole, through which said threaded pin is screwed.

4. The locating structure for eyeball-shaped camera as claimed in claim 1, further comprising an ornamental shell fixedly mounted on said mounting board to locate outside and shield said fixing housing.

5. The locating structure for eyeball-shaped camera as claimed in claim 4, wherein said mounting board includes mounting holes located between said fixing housing and said ornamental shell.
